(19) United States
(12) Patent Application Publication
(10) Pub. No.: US 2022/0043773 A1
(43) Pub. Date: Feb. 10, 2022

(54) INFORMATION PROCESSING METHOD, ELECTRONIC DEVICE, AND STORAGE MEDIUM

(71) Applicant: BEIJING BAIDU NETCOM SCIENCE TEHNOLOGY CO., LTD., Beijing (CN)

(72) Inventors: Weibin YE, Beijing (CN); Jintao Cui, Beijing (CN); Tao Liu, Beijing (CN)

(21) Appl. No.: 17/450,971

(22) Filed: Oct. 14, 2021

(30) Foreign Application Priority Data
Feb. 9, 2021 (CN) 202110178484.9

(51) Int. Cl. G06F 16/16; G06F 16/22

(52) U.S. Cl. CPC G06F 16/164; G06F 16/2282

(57) ABSTRACT

An information processing method, electronic device, and storage medium are provided, and relate to the technical field of big data. The method includes: acquiring meta information; wherein the meta information includes fields, corresponding to original network data, in a storage table, and is used to summarize a process of computing the original network data by an information processing job; the storage table is used to store results of the computing, of the information processing job, corresponding to respective fields; acquiring, according to the meta information, an association relationship between a data source of the original network data and the results of the computing, of the information processing job, corresponding to the respective fields; and returning the association relationship to a specified receiving address.

### CROSS-REFERENCE TO RELATED APPLICATION

This application claims priority to Chinese patent application No. 202110178484.9, filed on Feb. 9, 2021, which is hereby incorporated by reference in its entirety.

### TECHNICAL FIELD

The present disclosure relates to a technical field of a computer, in particular to a technical field of big data.

### BACKGROUND

In today's Internet age of big data, the amount of network data increases exponentially. Each enterprise will produce and process a large amount of high-value data having the characteristics of large scale, long links, and multiple participation roles. With the explosive growth of big data of enterprises, practical problems, such as data tracking, data management, data security, etc., inevitably arise. Therefore, data governance has become an important work that enterprises must carry out. A blood relationship between data is an important technology of data management. The blood relationship between data represents an association between data, and a blood relationship collection technology is a key technology point for carrying out the data governance. A unified blood tie library of enterprises is obtained by collecting the data blood relationship, so that a source and destination of each data can be known and therefore full-link data tracking, auditing, heat statistics, and invalid data cleaning can be well realized, resources can be saved, and the application can be wide.

### SUMMARY

The present disclosure provides an information processing method, apparatus, device, storage medium, and program product.

According to an aspect of the present disclosure, an information processing method is provided, which includes:
acquiring meta information; wherein the meta information includes fields, corresponding to original network data, in a storage table, and is used to summarize a process of computing the original network data by an information processing job; the storage table is used to store results of the computing, of the information processing job, corresponding to respective fields;
acquiring, according to the meta information, an association relationship between a data source of the original network data and the results of the computing, of the information processing job, corresponding to the respective fields; and
returning the association relationship to a specified receiving address.

According to another aspect of the present disclosure, an information processing method is provided, which includes:
acquiring a probe, the probe used to perform the information processing method, for acquiring an association relationship, provided by any one of the embodiments of the present disclosure;
combining the probe with an information processing job used to compute original network data, and submitting the combined probe and information processing job to a cluster system performing the information processing job; and
running the probe and the information processing job.

According to another aspect of the present disclosure, an electronic device is provided, which includes:
at least one processor; and
a memory communicatively connected to the at least one processor; wherein
the memory stores instructions executable by the at least one processor, and the instructions are executed by the at least one processor to enable the at least one processor to perform the method in any one of the embodiments of the present disclosure.

According to another aspect of the present disclosure, a non-transitory computer-readable storage medium storing computer instructions is provided. The computer instructions are used to cause a computer to perform the method in any one of the embodiments of the present disclosure.

It should be understood that the content described in this section is not intended to identify the key or important features of the embodiments of the present disclosure, and is not intended to limit the scope of the present disclosure. Other features of the present disclosure will be easily understood through the following description.

### BRIEF DESCRIPTION OF THE DRAWINGS

The accompanying drawings are used to better understand technical solution(s) of the present disclosure and should not be constructed a limitation to the present disclosure. Wherein:

FIG. 1 is a first schematic diagram of an information processing method according to an embodiment of the present disclosure;

FIG. 2 is a second schematic diagram of an information processing method according to an embodiment of the present disclosure;

FIG. 3 is a third schematic diagram of an information processing method according to an embodiment of the present disclosure;

FIG. 4 is a schematic diagram of a blood relationship processing system according to an example of the present disclosure;

FIG. 5 is a schematic diagram of processing data in a data frame format according to an example of the present disclosure;

FIG. 6A is a schematic diagram of a syntax tree according to an example of the present disclosure;

FIG. 6B is a schematic diagram of analyzing a syntax tree information according to an example of the present disclosure;

FIG. 7 is a first schematic diagram of an information processing apparatus according to an embodiment of the present disclosure;

FIG. 8 is a second schematic diagram of an information processing apparatus according to an embodiment of the present disclosure;

FIG. 9 is a third schematic diagram of an information processing apparatus according to an embodiment of the present disclosure;

FIG. 10 is a fourth schematic diagram of an information processing apparatus according to an embodiment of the present disclosure;

FIG. 11 is a fifth schematic diagram of an information processing apparatus according to an embodiment of the present disclosure;

FIG. 12 is a sixth schematic diagram of an information processing apparatus according to an embodiment of the present disclosure;

FIG. 13 is a seventh schematic diagram of an information processing apparatus according to an embodiment of the present disclosure;

FIG. 14 is an eighth schematic diagram of an information processing apparatus according to an embodiment of the present disclosure; and

FIG. 15 is a block diagram of an electronic device for implementing an information processing method of an embodiment of the present disclosure.

### DETAILED DESCRIPTION

The exemplary embodiments of the present disclosure will be described below in combination with the accompanying drawings, including various details of the embodiments of the present disclosure to facilitate understanding, which should be considered as exemplary only. Therefore, those skilled in the art should realize that various changes and modifications can be made to the embodiments described herein without departing from the scope and spirit of the present disclosure. Likewise, descriptions of well-known functions and structures are omitted in the following description for clarity and conciseness.

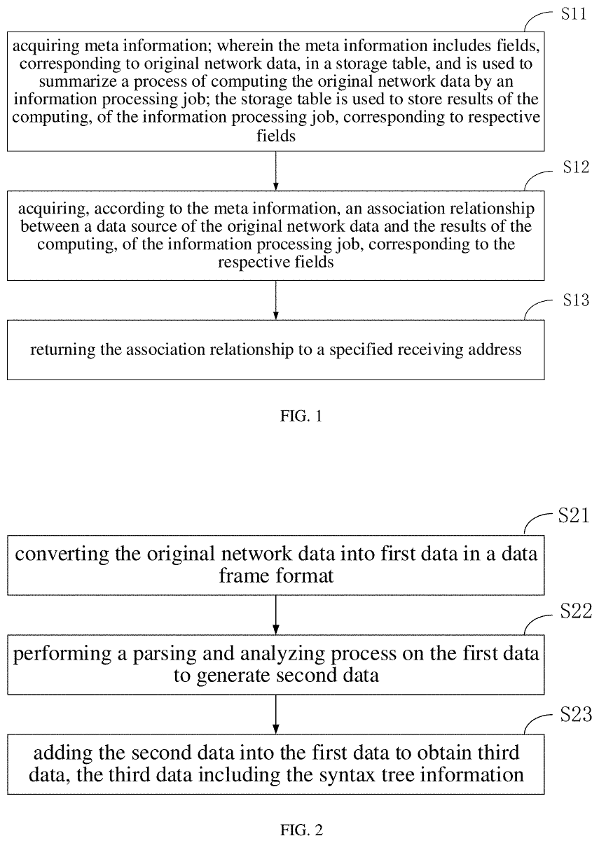

An embodiment of the present disclosure provides an information processing method. As shown in FIG. 1, the method includes:
S11: acquiring meta information; wherein the meta information includes fields, corresponding to original network data, in a storage table, and is used to summarize a process of computing the original network data by an information processing job; the storage table is used to store results of the computing, of the information processing job, corresponding to respective fields;
S12: acquiring, according to the meta information, an association relationship between a data source of the original network data and the results of the computing, of the information processing job, corresponding to the respective fields; and
S13: returning the association relationship to a specified receiving address.

In this embodiment, the meta information can include a storage table, fields in the storage table, descriptions on original network data, etc.

The meta information can be acquired before processing the original network data or during processing the original network data by the information processing job.

The meta information is used to summarize a process of computing the original network data by the information processing job, which can mean that the meta information includes an operation of computing the original network data by the information processing job, corresponding results and stored fields in a storage table, etc. For example, the meta information summarizes a process of computing a certain piece of original network data as a result of performing a second operation on a first data source to generate a third field.

In this embodiment, the storage table can be a storage table in a data storage library for storing results of processing or computing the original network data by the information processing job.

In this embodiment, the information processing job can be a job being run on a certain information processing platform, e.g. a job being run on a platform such as Spark, MapReduce, etc. When the information processing job is run, a series of processing can be performed on the original network data to generate a result of processing. For example, the information processing job can extract attribute information, such as user names, genders, etc., from the original network data.

The results of the computing, of the information processing job, corresponding to respective fields can refer to results, corresponding to respective fields of the storage table, in results generated by processing the original network data by the information processing job. The fields of the storage table can be categories corresponding to the results of the computing. For example, the storage table includes fields, such as age, gender, occupation, IP address, etc. The results of processing of the information processing job processing a certain piece of original network data are as follows: age A, gender B, and occupation C. Therefore, the result of the processing, of the information processing job, corresponding to the field “age” is A; the result of the processing corresponding to the field “gender” is B; and the result of the processing corresponding to the field “occupation” is C.

In this embodiment, the association relationship between the data source of the original network data and the results of the computing, of the information processing job, corresponding to the respective fields can be a data blood relationship between the data source of the original network data and the results of the computing.

The original network data can be big data such as an enterprise user portrait. Under the condition that the original network data is big data, the original network data can be characterized by large scale, data complexity, and structural and dimensional diversification, different from sporadic data. In the original network data, there can be hundreds of tags for one user. Address information of the user can be data obtained by processing the big data.

For example, for shopping applications, data such as user payments, transfer accounts, etc., and data such as e-commerce goods, prices, etc., are aggregated together in the background, including user relationships, goods information, social relationships between users, etc.

The original network data can also be all data of a whole enterprise or a whole company.

The data source of the original network data can be, for example, a data provider, a data collector, a data web site, a data acquisition address, etc. Specifically, it can be a data table for the original network data. For example, in the results of the computing, there is a blood relationship between the result C of the computing for the field “occupation” and a data source D.

In this embodiment, returning the association relationship to a specified receiving address can be returning the association relationship to a specified receiving system, and can be specifically returning the association relationship to a data storage library, etc.

In this embodiment, a field-level data association relationship can be acquired and returned, to improve the granularity of data association relationship information, and the source and destination of data fields can be tracked in a data governance product, to reduce the cost for manual checking.

In an implementation, the meta information includes syntax tree information when the information processing job is run, and acquiring, according to the meta information, the association relationship between the data source of the original network data and the results of the computing, of the information processing job, corresponding to the respective fields includes:
obtaining the data source of the original network data according to a leaf node in the syntax tree information;

obtaining information of operating the original network data according to an ancestor node of the leaf node, the information of the operating corresponding to at least one of the fields; and
acquiring, according to the information of the operating, the association relationship between the data source of the original network data and the results of the computing, of the information processing job, corresponding to the respective fields.

The syntax tree information includes a syntax tree when the information processing job is run, and other related variable information.

A leaf node of the syntax tree information and an ancestor node of the leaf node can refer to a leaf node of the syntax tree and a non-leaf node of the syntax tree in the syntax tree information, respectively, in this embodiment.

In the embodiment of the present disclosure, the leaf node of the syntax tree information corresponds to the data source of the original network data and can be generated during running the information processing job. An information processing job can include multiple pieces of syntax tree information, and each of the multiple pieces of syntax tree information can have multiple leaf nodes, i.e., correspond to multiple data sources.

In this embodiment, the ancestor node of the leaf node can include a root node of the syntax tree information.

In this embodiment, the ancestor node of the leaf node corresponds to an operation performed on the leaf node.

An association relationship between the data source corresponding to the leaf node and the results of computing for respective fields is determined according to the syntax tree information generated during running the information processing job, so that a comprehensive and complete association relationship can be obtained according to comprehensive information in the syntax tree information.

In an implementation, obtaining the information of the operating the original network data according to the ancestor node of the leaf node includes:
associating the data source corresponding to the leaf node with information of operating corresponding to ancestor nodes step-by-step until a root node of the syntax tree information is reached, to obtain all the information of the operating the original network data corresponding to nodes from a parent node of the leaf node to the root node.

In this embodiment, a depth-first traversal operation can be performed on the syntax tree information. The information of operating leaf nodes is aggregated upwards from the leaf nodes; the information of operating is associated with the data sources corresponding to the leaf nodes until the root node is aggregated to, so that all information of operating about the data sources corresponding to all the leaf nodes in the whole syntax tree information is obtained.

In this embodiment, information is aggregated upwards from the leaf node of the syntax tree information step-by-step, so that the speed and efficiency for acquiring the association relationship can be improved.

In an implementation, acquiring the meta information includes:

obtaining the syntax tree information through a programmable extension interface of an information processing job running platform.

In this embodiment, complete syntax tree information can be obtained through the programmable extension interface.

In an implementation, as shown in FIG. 2, the method further includes:
S21: converting the original network data into first data in a data frame format;
S22: performing a parsing and analyzing process on the first data to generate second data; and
S23: adding the second data into the first data to obtain third data, the third data including the syntax tree information.

In this embodiment, in at least one of the parsing operation and the analyzing, operation, supplementary data, i.e. the second data, for the first data is generated.

The second data is added into the first data to obtain the third data, so that the third data includes complete syntax tree information about a data association relationship.

In an implementation, obtaining the syntax tree information through the programmable extension interface of the information processing job running platform includes:
obtaining the third data through the programmable extension interface of the information processing job running platform; and
extracting the syntax tree information from the third data.

In this embodiment, the syntax tree information related to an association relationship between data is extracted only from the third data, so that the interference of useless data is avoided, the data processing amount is reduced, and the efficiency of performing an association information acquisition operation is ensured.

In an implementation, the meta information includes read-write information when the information processing job is operated, and acquiring, according to the meta information, the association relationship between the data source of the original network data and the results of the computing, of the information processing job, corresponding to the respective fields includes:
extracting the fields from the read-write information; and
determining an association relationship between the extracted fields and the data source.

In this embodiment, for an information processing job that directly performs a read-write operation on the original network data, the relationship between the fields and the data source can be directly acquired according to read-write information when the information processing job is operated.

The association relationship between the fields and the data source is directly extracted, such that the operation is simple, the number of the steps is less, and the efficiency is higher.

In an implementation, acquiring the meta information includes:
performing a dynamic agent operation of load time weaving on the information processing job; and
obtaining the meta information through the dynamic agent operation.

In this embodiment, an operation capable of obtaining the meta information can be enhanced during the dynamic agent, and the meta information can be obtained through the enhanced operation.

In this embodiment, the meta information is obtained during the dynamic agent, so that data can be acquired impalpably, and a modification operation does not need to be performed on the information processing job, which is performed simplify, easy to be implemented, and does not affect the original running on the information processing job.

In an implementation, returning the association relationship to the specified receiving address includes:
packaging the association relationship and sending the packaged association relationship to a message queue at the receiving address in real time.

In this embodiment, an association relationship is sent in real time, so that a downstream system can timely acquire the association relationship between data, which improves the timeliness.

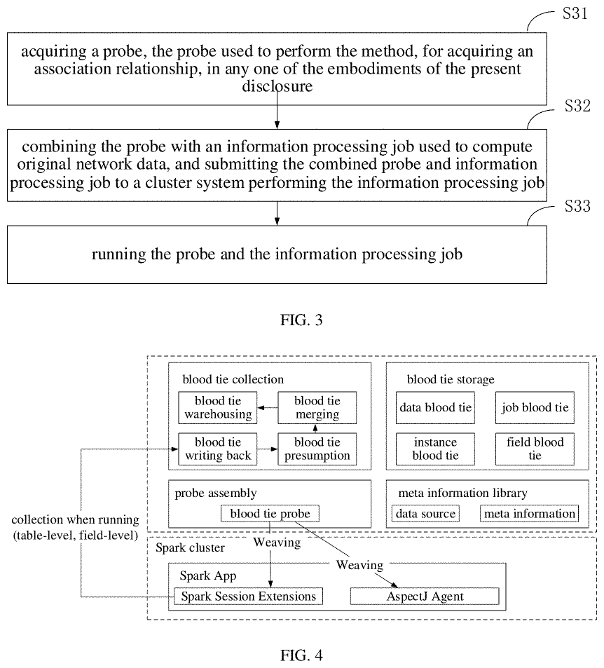

An embodiment of the present disclosure also provides an information processing method. As shown in FIG. 3, the method includes:
S31: acquiring a probe, the probe used to perform the method, for acquiring an association relationship, in any one of the embodiments of the present disclosure;
S32: combining the probe with an information processing job used to compute original network data, and submitting the combined probe and information processing job to a cluster system performing the information processing job; and
S33: running the probe and the information processing job.

In this embodiment, the probe can be a special program. Through the probe, an impalpable weaving method can perform meta information extraction and analysis operations when the information processing job is run.

The probe in this embodiment can perform an impalpable weaving job in the link of submitting the information processing job, so that non-invasive blood tie collection is realized. Meanwhile, since the probe can directly access and parse the syntax tree when the information processing job is run, field-level blood tie information can be collected.

In an implementation, combining the probe with the information processing job used to compute the original network data, and submitting the combined probe and information processing job to the cluster system performing the information processing job includes:
intercepting a command of submitting the information processing job; and
extending a command parameter of the command of the submitting, so that the probe is submitted to the cluster system along with the information processing job.

In this embodiment, while the information processing job can be ensured to be run, the probe can also start to run, so as to ensure that the probe can obtain all the meta information of the original network data processed by the information processing job.

In some possible implementations, there is extensibility for different job types, and only corresponding probes need to be achieved for jobs of various different job types. For example, different probes are constructed respectively for a Hive structured query language (HiveSQL) analysis job, a MapReduce computing job, a Spark computing job, and a Sqoop dump job, and the functions of extracting meta information and analyzing an association relationship between data are achieved for different jobs.

In this embodiment, the probe is adopted to specifically acquire an association relationship between information, so that an association relationship between the source of the original network data and the results of computing the original network data can be acquired impalpably without changing the composition of the information processing job.

In a specific example of the present disclosure, the “blood relationship” is used to represent an association relationship between the source of the original network data and the results of computing the original network data.

In some specific possible implementations, the action timing of the probe can vary for different job types.

For example, for the HiveSQL, MapReduce, and Sqoop jobs, the probe can act on a link of submitting a job, to acquire and analyze the meta information after parsing a command of submitting a job.

For the Spark job, the probe can act on a link when a job is run, to probe a performing plan of a Spark program.

For the two probing links, the information processing method provided by the embodiment of the present disclosure can effectively acquire input data and output data of a job.

In a possible implementation, the probe can read fields of a storage table, descriptions on the original network data processed by the information processing job, and file paths in the storage table and a file system, etc. For example, the probe can detect that a click operation is performed on the original network data.

In a possible implementation, the manner in which the probe captures the meta information can include: two types, acquiring the syntax tree information and directly acquiring information of a read-write operation on the original network data, corresponding to a Dataframe probe for acquiring and analyzing the syntax tree information and a resilient distributed dataset (RDD) probe for acquiring and analyzing the information of the read-write operation.

In a possible implementation, after an SQL request to start an information processing job is sent, a Spark platform runs an information processing job, operates data through an operator provided by a DataFrame operator, and generates first data in a data frame format according to the original network data. The first data is operated through a SparkSQL performing plan module. The performing plan module includes a SparkSQL Catalyst (SparkSQL performing plan optimizer). The first data is processed by several links, i.e., a parser, an analyzer, an optimizer, and a planner, of the SparkSQL Catalyst. The first data of a DataFrame structure is sequentially input to four models, i.e., an unresolved logical plan model, a logical plan model, an optimized logical plan model, and a physical plan model, for processing. As shown in FIG. 5, the unresolved logical plan model generates supplementary data for the first data, the supplementary data, i.e., the second data, including information such as categories, catalogs, etc. In the logical plan model, the second data is added into the first data to generate third data. The third data carries all the information required for blood tie collection, including a syntax tree and related variables. After extracting the third data in the logical plan model, data cannot be extracted in the subsequent optimized logical plan model, physical plan model, cost model, or selected physical plan model.

The Dataframe probe in this example can probe and acquire data of the logical plan model, to obtain the syntax tree information.

In a possible implementation, variable information such as a syntax tree when the information processing job runs in the logical plan model, etc., can be obtained as the syntax tree information by interfacing Spark Optimizer extension interfaces exposed by Spark Session Extensions (a programmable extension API exposed to users by a Spark frame).

In a possible implementation, after the probe when running captures original meta information data, the data needs to be filtered, converted, and finally parsed into a data format required for blood tie storage.

In a possible implementation, for the syntax tree information obtained in the logical plan model, the Dataframe probe obtains the blood relationship according to the syntax tree in the syntax tree information. The nodes of the syntax tree have more content, including a specific operation on a specific field of a specific storage table. The probe needs to parse the syntax tree.

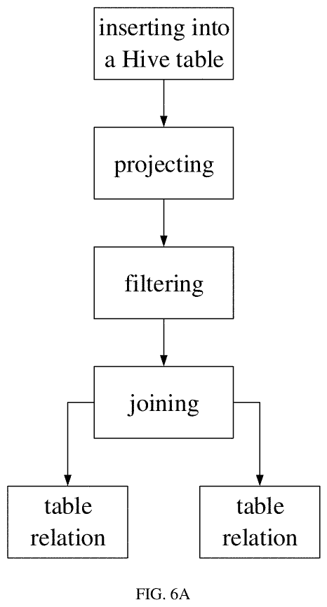

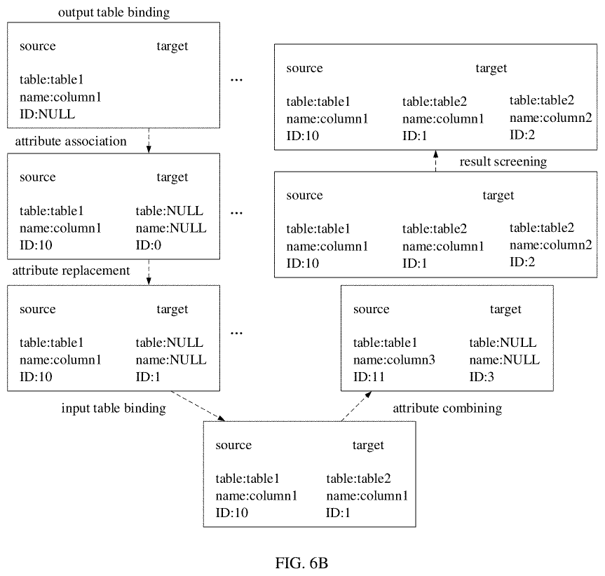

In a possible implementation, the syntax tree is shown in FIG. 6A, including operations of joining, filtering, projecting, and inserting two table relations into a Hive table sequentially. The analyzing operation performed on the syntax tree is shown in FIG. 6B. The Dataframe probe filters a performing plan that needs to be resolved according to a Logical Plan root node type, to leave only related parts of a write data operation. Then, a depth-first search (DFS) algorithm is used to traverse respective syntax trees obtained by filtering in Logical Plan in a postorder traversal manner. When each syntax tree is traversed, attribute IDs of data sources, of original network data (output tables) such as an input table, etc., corresponding to leaf nodes are associated with IDs of names of fields corresponding to respective nodes, the associated information is taken to parent nodes, and the same attribute IDs of the parent nodes are merged (attribute combining). In the merging process, through attribute replacement, the same operation or the same field of the same table is de-duplicated and integrated, and the operation corresponding to the same field of the same table can be integrated together. The merging operation is repeated until final merging information is aggregated at a root node, and the field information of the input table is completely merged. The information aggregated at the root node can be screened finally to remove some operations which have no practical significance, such as operations which only participate in a computing process and do not generate a result of the computing.

In this example, in order to distinguish fields with the same name, each field in each table is assigned with an ID. For example, for a table named “table1,” a field named “column1” therein is assigned with an ID number of 10; for a table named “table2,” a field named “column1” therein is assigned with an ID number of 1; for the table named “table2,” a field named “column1” therein is assigned with an ID number of 2; and, for the table named “table1,” a field named “column3” therein is assigned with an ID number of 11.

According to the sequence of respective fields in the total information obtained after merging, the fields of the output table are associated with the field of the merged input table, to obtain field-level blood tie information. It is considered that partial nodes in the syntax tree only participate in the computing process and are not directly converted into results of the computing. For example, filtering, sorting, and grouping nodes in the syntax tree only perform operations, such as filtering and adding sorting and grouping information, etc., on the original network data without generating the results of the computing. In this case, a field blood tie can be identified as a strong association or a weak association according to the node type, and is attached into the merging information as part of a meta information parsing result. The operations corresponding to the nodes have large or small influence factors on the original network data. In this example, distinguishing the large or small influence factors on the original network data can extend an application plane of the probe, which not only can know a field-level blood relationship, but also can know the strength or weakness of the blood relationship.

In a possible implementation, an RDD probe is used to acquire meta information for an information processing job directly reading/writing data for an RDD operation. After acquisition, the syntax tree processing can no longer be performed, which is equivalent to acquiring data of an RDDs model shown in FIG. 5. Considering that a Spark job program is run on a Java virtual machine (JVM), a load time weaving (LTW) technology can be used to perform a dynamic agent on RDD-related Java category in the JVM. During the dynamic agent, the Java category of the information processing job is enhanced. After the dynamic agent, an agent layer is included outside the category. The agent layer performs all operations. The agent layer enhances the concerned operations in the performing process, takes the meta information first, and then performs the original operation of the information processing job to be agented.

For example, the information processing job originally contains a +1 operation, blood tie-related meta information is first taken during the dynamic agent, and then the agent layer is used to perform the +1 operation.

In this embodiment, a command of submitting a Spark job from a client (Spark APP) can be intercepted, and command parameters are extended, so that a pre-compiled probe package is submitted to a computing cluster along with the Spark job to take effect when running.

After the parsing when running is completed, the probe has collected all valid blood tie information of a single information processing job. At this moment, in order to connect blood tie collected by all jobs in series and write the same into a centralized blood tie library, the data of the probe needs to be returned, i.e. written back. The implementation method thereof is: packaging the collected blood tie information and sending the packaged blood tie information to a message queue in real time for subscription by a downstream system using blood tie data.

The solution provided by the example of the present disclosure can realize non-invasive and field-level data blood relationship collection.

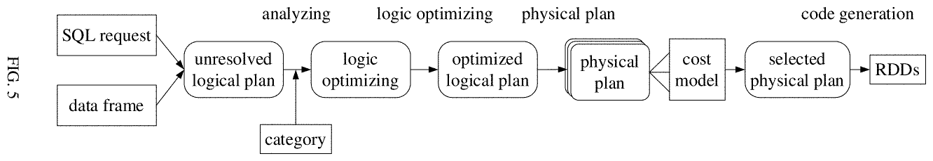

In an example of the present disclosure, the process of establishing a blood relationship, as shown in FIG. 4, includes two operations: blood tie collection and blood tie storage. This example extracts the meta information through the Spark Session Extensions of the Spark APP, or uses an AspectJ Agent of an LTW technology to implement a dynamic agent function to extract the meta information.

A probe is woven through a job weaving manner, meta information is acquired, a blood relationship is obtained according to the meta information, and the blood relationship is written back to a corresponding downstream system, so that the downstream system can perform the operations of blood tie presumption, blood tie merging, and blood tie warehousing. Further, after the blood tie is warehoused, the blood tie can be correspondingly stored in a configured storage space, such as a data blood tie storage space, an instance blood tie storage space, a field blood tie storage space, and a job blood tie storage space.

The extracted meta information can be stored in a meta information library, which can include the data source and meta information.

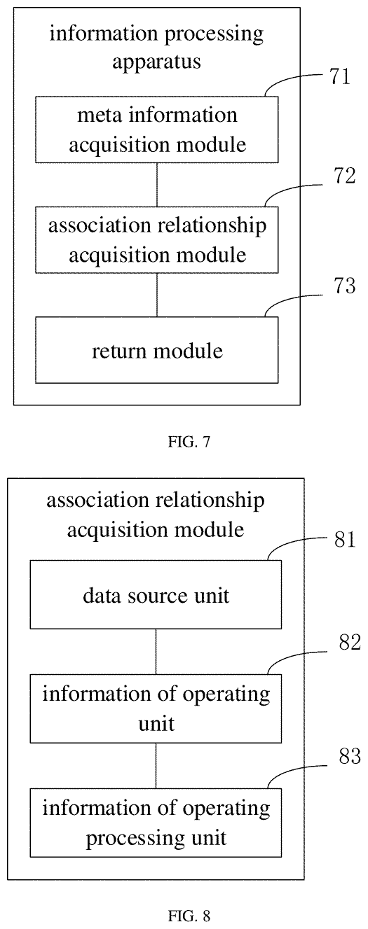

An embodiment of the present disclosure also provides an information processing apparatus. As shown in FIG. 7, the apparatus includes:
a meta information acquisition module 71, configured for acquiring meta information; wherein the meta information includes fields, corresponding to original network data, in a storage table, and is used to summarize a process of computing the original network data by an information processing job; the storage table is used to store results of the computing, of the information processing job, corresponding to respective fields;
an association relationship acquisition module 72, configured for acquiring, according to the meta information, an association relationship between a data source of the original network data and the results of the computing, of the information processing job, corresponding to the respective fields; and
a return module 73, configured for returning the association relationship to a specified receiving address.

In an implementation, the meta information includes syntax tree information when the information processing job is run; and as shown in FIG. 8, the association relationship acquisition module includes:
a data source unit 81, configured for obtaining the data source of the original network data according to a leaf node in the syntax tree information;
an information of operating unit 82, configured for obtaining information of operating the original network data according to an ancestor node of the leaf node, the information of the operating corresponding to at least one of the fields; and
an information of operating processing unit 83, configured for acquiring, according to the information of the operating, the association relationship between the data source of the original network data and the results of the computing, of the information processing job, corresponding to the respective fields.

In an implementation, the information of operating unit is further configured for:
associating the data source corresponding to the leaf node with information of operating corresponding to ancestor nodes step-by-step until a root node of the syntax tree information is reached, to obtain all the information of the operating the original network data corresponding to nodes from a parent node of the leaf node to the root node.

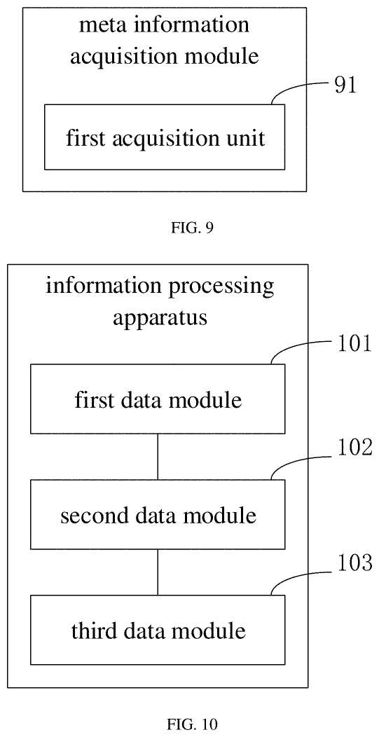

In an implementation, as shown in FIG. 9, the meta information acquisition module includes:
a first acquisition unit 91, configured for obtaining the syntax tree information through a programmable extension interface of an information processing job running platform.

In an implementation, as shown in FIG. 10, the information processing apparatus further includes:
a first data module 101, configured for converting the original network data into first data in a data frame format;
a second data module 102, configured for performing a parsing and analyzing process on the first data to generate second data; and
a third data module 103, configured for adding the second data into the first data to obtain third data, the third data including the syntax tree information.

In an implementation, the first acquisition unit is further configured for:
obtaining the third data through the programmable extension interface of the information processing job running platform; and
extracting the syntax tree information from the third data.

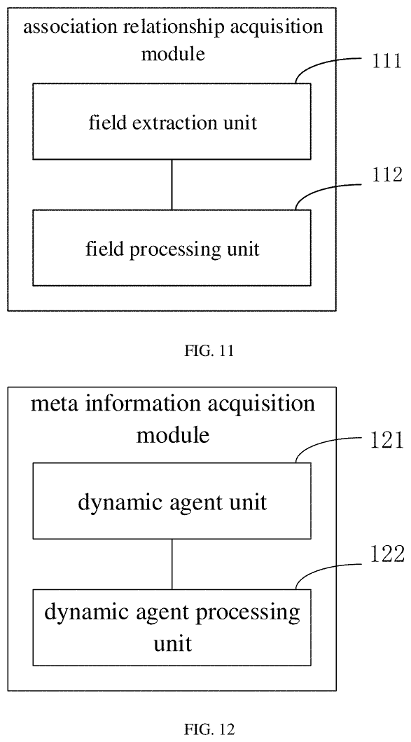

In an implementation, as shown in FIG. 11, the meta information includes read-write information when the information processing job is operated, and the association relationship acquisition module includes:
a field extraction unit 111, configured for extracting the fields from the read-write information; and
a field processing unit 112, configured for determining an association relationship between the extracted fields and the data source.

In an implementation, as shown in FIG. 12, the meta information acquisition module includes:
a dynamic agent unit 121, configured for performing a dynamic agent operation of load time weaving on the information processing job; and
a dynamic agent processing unit 122, configured for obtaining the meta information through the dynamic agent operation.

In an implementation, the return module is further configured for:
packaging the association relationship and sending the packaged association relationship to a message queue at the receiving address in real time.

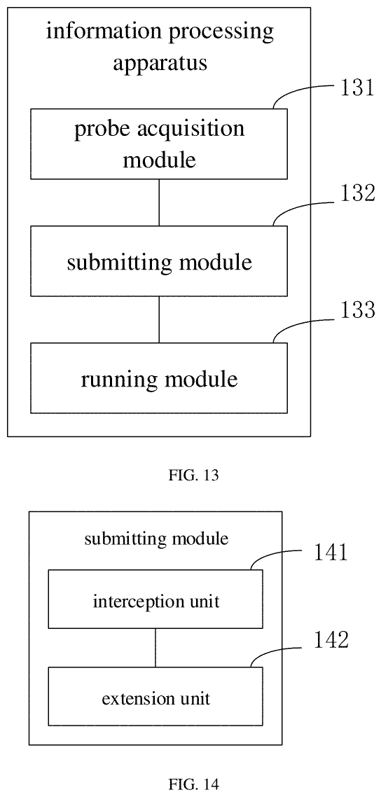

An embodiment of the present disclosure also provides an information processing apparatus. As shown in FIG. 13, the apparatus includes:
a probe acquisition module 131, configured for acquiring a probe, the probe including any information processing apparatus, for acquiring an association relationship, provided by the embodiments of the present disclosure;
a submitting module 132, configured for combining the probe with an information processing job used to compute original network data, and submitting the combined probe and information processing job to a cluster system performing the information processing job; and
a running module 133, configured for running the probe and the information processing job.

In an implementation, as shown in FIG. 14, the submitting module includes:
an interception unit 141, configured for intercepting a command of submitting the information processing job; and
an extension unit 142, configured for extending a command parameter of the command of the submitting, so that the probe is submitted to the cluster system along with the information processing job.

According to embodiments of the present disclosure, the present disclosure also provides an electronic device, a readable storage medium, and a computer program product.

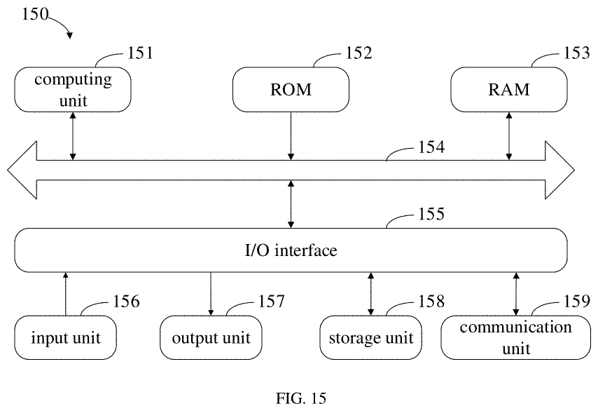

FIG. 15 illustrates a schematic block diagram that can be used to implement an example electronic device 150 of an embodiment of the present disclosure. The electronic device is intended to represent various forms of digital computers, such as laptop computers, desktop computers, workstations, personal digital assistants, servers, blade servers, mainframe computers, and other suitable computers. The electronic device can also represent various forms of mobile apparatuses, such as personal digital processing, cellular telephone, smart phone, wearable device, and other similar computing apparatuses. The parts, connections and relationships thereof, and functions thereof shown herein are merely examples and are not intended to limit the implementation of the present disclosure described and/or claimed herein.

As shown in FIG. 15, the electronic device 150 includes a computing unit 151 that can perform various suitable actions and processes in accordance with a computer program stored in a read-only memory (ROM) 152 or a computer program loaded from a storage unit 158 into a random access memory (RAM) 153. In the RAM 153, various programs and data required for the operation of the electronic device 150 can also be stored. The computing unit 151, the ROM 152 and the RAM 153 are connected to each other via a bus 154. An input output (I/O) interface 155 is also connected to the bus 154.

A plurality of parts in the electronic device 150 are connected to an I/O interface 155, including: an input unit 156, such as a keyboard, a mouse, etc.; an output unit 157, such as various types of displays, speakers, etc.; a storage unit 158, such as a magnetic disk, an optical disk, etc.; and a communication unit 159, such as a network card, a modem, a wireless communication transceiver, etc. The communication unit 159 allows the electronic device 150 to exchange information/data with other devices via a computer network, such as the Internet, and/or various telecommunications networks.

The computing unit 151 can be a variety of general purpose and/or special purpose processing components having processing and computing capabilities. Some examples of the computing unit 151 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 151 performs various methods and processes described above, such as the information processing method. For example, in some embodiments, the information processing method can be implemented as a computer software program tangibly contained in a machine-readable medium, such as a storage unit 158. In some embodiments, part or all of the computer program can be loaded and/or installed on the electronic device 150 via the ROM 152 and/or the communication unit 159. When a computer program is loaded into the RAM 153 and executed by the computing unit 151, one or more steps of the above-described information processing method can be performed. Alternatively, in other embodiments, the computing unit 151 can be configured to perform the information processing method by any other suitable means (e.g., via firmware).

Various implementations of the systems and techniques described herein above can be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or combinations thereof. These various implementations can include: implementing in one or more computer programs, which can be executed and/or interpreted on a programmable system including at least one programmable processor. The programmable processor can be a dedicated or general-purpose programmable processor that can receive data and instructions from a storage system, at least one input device, and at least one output device, and transmit the data and instructions to the storage system, the at least one input device, and the at least one output device.

Program codes for implementing the methods of the present disclosure can be written in any combination of one or more programming languages. These program codes can be provided to processors or controllers of general purpose computers, special purpose computers, or other programmable data processing apparatuses, such that the program codes, when executed by the processors or the controllers, cause the functions/operations specified in the flowchart and/or block diagram to be implemented. The program codes can execute entirely on a machine, partly on a machine, partly on a machine as a stand-alone software package and partly on a remote machine or entirely on a remote machine or a server.

In the context of the present disclosure, a machine-readable medium can be a tangible medium that can contain or store a program for use by an instruction execution system, apparatus, or device or in connection with the instruction execution system, apparatus, or device. The machine-readable medium can be a machine-readable signal medium or a machine-readable storage medium. The machine-readable medium can include, but is not limited to, an electronic, magnetic, optical, electromagnetic, infrared, or semiconductor system, apparatus, or device, or any suitable combination thereof. More specific examples of a machine-readable storage medium can include one or more wires-based electrical connections, a portable computer diskette, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination thereof.

In order to provide the interaction with a user, the system and technology described herein can be implemented on a computer that has: a display apparatus (e.g., a CRT (cathode ray tube) or an LCD (liquid crystal display) monitor) for displaying information to the user; and a keyboard and a pointing apparatus (e.g., a mouse or a trackball) through which the user can provide input to the computer. Other types of apparatuses can also be used to provide the interaction with a user: for example, the feedback provided to the user can be any form of sensory feedback (e.g., visual feedback, auditory feedback, or tactile feedback); and input from the user can be received in any form (including acoustic input, voice input, or tactile input).

The system and technology described herein can be implemented in a computing system (e.g., as a data server) that includes a background part, or be implemented in a computing system (e.g., an application server) that includes a middleware part, or be implemented in a computing system (e.g., a user computer having a graphical user interface or a web browser, through which a user can interact with implementations of the system and technology described herein) that includes a front-end part, or be implemented in a computing system that includes any combination of such background part, middleware part, or front-end part. The parts of the system can be interconnected by any form or medium of the digital data communication (e.g., a communication network). Examples of the communication network include: a Local Area Networks (LAN), a Wide Area Network (WAN), and the Internet.

A computer system can include a client and a server. The client and server are typically remote from each other and typically interact through a communication network. The relation of the client and the server is generated by computer programs running on respective computers and having a client-server relation with each other.

It should be understood that various forms of processes shown above can be used to reorder, add, or delete steps. For example, respective steps recorded in the present disclosure can be executed in parallel, or can be executed sequentially, or can be executed in a different order, so long as the desired result of the technical solution provided in the present disclosure can be achieved, no limitation is made herein.

The above-mentioned specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement, and the like made within the spirit and principle of the present disclosure shall be included within the protection scope of the present disclosure.

What is claimed is:

1. An information processing method, comprising:
acquiring meta information; wherein the meta information comprises fields, corresponding to original network data, in a storage table, and is used to summarize a process of computing the original network data by an information processing job; the storage table is used to store results of the computing, of the information processing job, corresponding to respective fields;
acquiring, according to the meta information, an association relationship between a data source of the original network data and the results of the computing, of the information processing job, corresponding to the respective fields; and
returning the association relationship to a specified receiving address.

2. The method of claim 1, wherein the meta information comprises syntax tree information when the information processing job is run, and the acquiring, according to the meta information, the association relationship between the data source of the original network data and the results of the computing, of the information processing job, corresponding to the respective fields comprises:
obtaining the data source of the original network data according to a leaf node in the syntax tree information;
obtaining information of operating the original network data according to an ancestor node of the leaf node, the information of the operating corresponding to at least one of the fields; and
acquiring, according to the information of the operating, the association relationship between the data source of the original network data and the results of the computing, of the information processing job, corresponding to the respective fields.

3. The method of claim 2, wherein the obtaining the information of the operating the original network data according to the ancestor node of the leaf node comprises:
associating the data source corresponding to the leaf node with information of operating corresponding to ancestor nodes step-by-step until a root node of the syntax tree information is reached, to obtain all the information of the operating the original network data corresponding to nodes from a parent node of the leaf node to the root node.

4. The method of claim 2, wherein the acquiring the meta information comprises:
obtaining the syntax tree information through a programmable extension interface of an information processing job running platform.

5. The method of claim 4, wherein the method further comprises:
converting the original network data into first data in a data frame format;
performing a parsing and analyzing process on the first data to generate second data; and
adding the second data into the first data to obtain third data, the third data comprising the syntax tree information.

6. The method of claim 5, wherein the obtaining the syntax tree information through the programmable extension interface of the information processing job running platform comprises:
obtaining the third data through the programmable extension interface of the information processing job running platform; and
extracting the syntax tree information from the third data.

7. The method of claim 1, wherein the meta information comprises read-write information when the information processing job is operated, and the acquiring, according to the meta information, the association relationship between the data source of the original network data and the results of the computing, of the information processing job, corresponding to the respective fields comprises:
extracting the fields from the read-write information; and
determining an association relationship between the extracted fields and the data source.

8. The method of claim 7, wherein the acquiring the meta information comprises:
performing a dynamic agent operation of load time weaving on the information processing job; and
obtaining the meta information through the dynamic agent operation.

9. The method of claim 1, wherein the returning the association relationship to the specified receiving address comprises:
packaging the association relationship and sending the packaged association relationship to a message queue at the receiving address in real time.

10. An information processing method, comprising:
acquiring a probe, the probe used to perform the method of claim 1;
combining the probe with an information processing job used to compute original network data, and submitting the combined probe and information processing job to a cluster system performing the information processing job; and
running the probe and the information processing job.

11. The method of claim 10, wherein the combining the probe with the information processing job used to compute the original network data, and submitting the combined probe and information processing job to the cluster system performing the information processing job comprises:
intercepting a command of submitting the information processing job; and
extending a command parameter of the command of the submitting, so that the probe is submitted to the cluster system along with the information processing job.

12. An electronic device, comprising:
at least one processor; and
a memory communicatively connected to the at least one processor; wherein
the memory stores instructions executable by the at least one processor, and the instructions are executed by the at least one processor to enable the at least one processor to perform operations of:
acquiring meta information; wherein the meta information comprises fields, corresponding to original network data, in a storage table, and is used to summarize a process of computing the original network data by an information processing job; the storage table is used to store results of the computing, of the information processing job, corresponding to respective fields;
acquiring, according to the meta information, an association relationship between a data source of the original network data and the results of the computing, of the information processing job, corresponding to the respective fields; and
returning the association relationship to a specified receiving address.

13. The electronic device of claim 12, wherein the meta information comprises syntax tree information when the information processing job is run, and when the instructions are executed by the at least one processor to enable the at least one processor to acquire, according to the meta information, the association relationship between the data source of the original network data and the results of the computing, of the information processing job, corresponding to the respective fields, the instructions are executed by the at least one processor to enable the at least one processor to specifically perform operations of:
obtaining the data source of the original network data according to a leaf node in the syntax tree information;
obtaining information of operating the original network data according to an ancestor node of the leaf node, the information of the operating corresponding to at least one of the fields; and
acquiring, according to the information of the operating, the association relationship between the data source of the original network data and the results of the computing, of the information processing job, corresponding to the respective fields.

14. The electronic device of claim 13, wherein when the instructions are executed by the at least one processor to enable the at least one processor to obtain the information of the operating the original network data according to the ancestor node of the leaf node, the instructions are executed by the at least one processor to enable the at least one processor to specifically perform an operation of:
associating the data source corresponding to the leaf node with information of operating corresponding to ancestor nodes step-by-step until a root node of the syntax tree information is reached, to obtain all the information of the operating the original network data corresponding to nodes from a parent node of the leaf node to the root node.

15. The electronic device of claim 13, wherein when the instructions are executed by the at least one processor to enable the at least one processor to acquire the meta information, the instructions are executed by the at least one processor to enable the at least one processor to specifically perform an operation of:
obtaining the syntax tree information through a programmable extension interface of an information processing job running platform.

16. The electronic device of claim 15, wherein the instructions are executed by the at least one processor to enable the at least one processor to further perform operations of:
converting the original network data into first data in a data frame format;
performing a parsing and analyzing process on the first data to generate second data; and
adding the second data into the first data to obtain third data, the third data comprising the syntax tree information.

17. The electronic device of claim 16, wherein when the instructions are executed by the at least one processor to enable the at least one processor to obtain the syntax tree information through the programmable extension interface of the information processing job running platform, the instructions are executed by the at least one processor to enable the at least one processor to specifically perform operations of:
obtaining the third data through the programmable extension interface of the information processing job running platform; and
extracting the syntax tree information from the third data.

18. An electronic device, comprising:
at least one processor; and
a memory communicatively connected to the at least one processor; wherein
the memory stores instructions executable by the at least one processor, and the instructions are executed by the at least one processor to enable the at least one processor to perform the method of claim 10.

19. A non-transitory computer-readable storage medium storing computer instructions for enabling a computer to perform operations of:
acquiring meta information; wherein the meta information comprises fields, corresponding to original network data, in a storage table, and is used to summarize a process of computing the original network data by an information processing job; the storage table is used to store results of the computing, of the information processing job, corresponding to respective fields;
acquiring, according to the meta information, an association relationship between a data source of the original network data and the results of the computing, of the information processing job, corresponding to the respective fields; and
returning the association relationship to a specified receiving address.

20. A non-transitory computer-readable storage medium storing computer instructions for enabling a computer to perform the method of claim 10.
